(19) United States
(12) Patent Application Publication
(10) Pub. No.: US 2001/0037245 A1
(43) Pub. Date: Nov. 1, 2001

(54) Point of sale device, e-commerce system, and method and apparatus for order processing and inventory management

(76) Inventors: Krishnappa Ranganath, San Jose, CA (US); Naveen Mandhana, Bombay (IN)

Correspondence Address: WELLS ST JOHN ROBERTS GREGORY AND MATKIN, SUITE 1300, 601 W FIRST AVENUE, SPOKANE, WA, 992013828

(21) Appl. No.: 09/827,725

(22) Filed: Apr. 6, 2001

Related U.S. Application Data
(60) Provisional application No. 60/196,034, filed on Apr. 7, 2000.

(51) Int. Cl. G06F 17/60; G06G 1/14

(52) U.S. Cl. 705/16; 705/22

(57) ABSTRACT

A point of sale device includes a housing; a processor supported by the housing; a printer coupled to the processor and supported by the housing; a display coupled to the processor and supported by the housing; a keypad coupled to the processor and supported by the housing; and a communications interface coupled to the processor and supported by the housing, the communications interface being configured to communicate with a server via the Internet.

### CROSS REFERENCE TO RELATED APPLICATION

This application claims priority to U.S. Provisional Application Ser. No. 60/196,034, filed Apr. 7, 2000.

### TECHNICAL FIELD

The invention relates to the field of e-commerce or Internet based shops and point of sale systems and methods.

### BACKGROUND OF THE INVENTION

Retailers or merchants can establish e-commerce shops on the Internet to promote and sell their products. These retailers need a way to download and process the orders placed by the consumers. Consumers, who have placed orders with these retailers on the Internet, need real time updates on the status of their orders.

Retailers can publish e-commerce shops on the Internet either by themselves by, for example, creating it using off the shelf publishing software, or by hiring someone to develop it, such as an Internet service provider. If an Internet service provider is used, the Internet service provider collects all the necessary information from the retailer, and creates a shop using a web server.

Whether the e-commerce shops are created by an Internet service provider or by the retailer, different publishing schemes are possible. Static publishing allows a user to put all the data directly on the web server using HTML, and any change of a published item using this scheme requires re-publishing the site. In dynamic publishing, the web server interacts with or includes a database to publish the posted inventory on demand, and separate utilities can modify the inventory items stored in the database. The methods and apparatus, disclosed in the following Detailed Description of applicants' invention apply more particularly to dynamic publishing, that is, for Internet shops that publish inventory information retrieved from a database.

A commonly known method for managing inventory and processing consumers placed orders involves the steps listed below or a combination of the steps listed below:

1. After the consumer places the order, the server software sends the order through e-mail, fax or telephone. In some cases, where the retailer has access to a web site for a web server, he or she can log on to the server and see the orders pending for process. Some of the servers are capable of integrating the orders in to the retailer's existing enterprise information system software to automate the order shipment and tracking.

2. The published inventory has to be managed, sometimes the price needs to be updated, or certain inventory items may have to be added or deleted. In such cases where the retailer has access to a web site for the web server, the web server may have utilities, which can be used to manage the inventory. The retailer has to use a computer to access the web site. Retailers without direct access need to send faxes, e-mails or need to make telephone calls to manage inventory.

Some retailers, particularly small ones, lack automation to process the orders and they or their employees lack sufficient computer skills to use web based inventory management systems. For these retailers, the only way today to manage inventory or process orders is by fax, telephone, or e-mail. These methods require much interaction with and reliance on others (e.g. the Internet service provider), requiring additional human intervention and, therefore, increased costs. Relying on others can result in delays in updating the web site, due to lack of capacity of the Internet service provider, and the retailer lacks control. Minor errors may go uncorrected due to the amount of effort required and dependence on others. Publication of price changes or lack of inventory may not be implemented quickly enough, potentially resulting in loss of revenues or customer dissatisfaction.

### SUMMARY OF THE INVENTION

The invention provides a retail point of sale device, which is coupled to an Internet e-commerce shop server through an application server. This device provides the retailer or merchant with the ability to process the order, and manage the published inventory of the e-commerce shop from the retail premises.

One aspect of the invention provides a system including the point of sale device and the application server. In this embodiment, the application server, by monitoring the actions the retailer or merchant performs on the point of sale device, and by using retailer or merchant specified parameters, reports the status of the order to consumers.

The invention disclosed herein provides a point of sale style device that can easily be used by a retailer or employee that has the skills to operate a cash register or point of sale devices. In one aspect of the invention, the device includes a micro-controller/microprocessor, display, keypad, printer, and embedded software and provides an interface with which the retailer or employee can use to access an Internet shop server, via the application server. Using this simple point of sale device and installing corresponding software at the server, the retailer or employee can receive the orders online, manage the inventory and consumers can get live updates on the status of order.

One aspect of the invention provides a system including the point of sale device, and a shop server. A web site for the retailer is defined by the shop server. The shop server includes or accesses a database including information that, when requested, is published dynamically on the retailer's web site. When there is a request from a consumer, the Internet shop server retrieves the information from the database and formats it into a standard Internet document and displays that to the consumer. In one embodiment, the application server is defined by the shop server instead of being a separate server.

In operation, prior to using the point of sale device, when the retailer first opens a shop on the Internet, he or she will input the necessary information about the shop and the inventory he or she is ready to sell online. Shop specific information, such as time of operation, reservation, shipping, and delivery information need to be updated only once in while. The inventory items and associated prices need to be updated on regular basis depending on the market conditions.

In one aspect of the invention, by using the point of sale device, a retailer can change inventory and prices. In another aspect of the invention, by using the point of sale device, a retailer can further change shop specific information such as like time of operation, reservation, shipping, delivery service. The retailers can sell products, services, provide an opportunity for consumers to reserve restaurant seating, and allow other such functions that are presently practiced in online commerce.

### BRIEF DESCRIPTION OF THE DRAWINGS

FIG. 1 is a block diagram of a system embodying various aspects of the invention and including a point of sale device and an application server.

FIG. 2 is a detailed view of the point of sale device included in the system of FIG. 1.

FIG. 3 is a flowchart illustrating the way the application server and point of sale device of FIG. 1 interact to perform real time order processing and inventory management.

FIG. 4 is continuation of the flow chart from FIG. 3.

FIG. 5 illustrates a keypad and display of a point of sale device, in which the display shows a change price screen, from which the price of a product can be changed using the point of sale device.

FIG. 6 illustrates a keypad and display of a point of sale device, in which the display shows a change product status screen, from which the availability status of a product can be changed using the point of sale device.

FIG. 7 illustrates a keypad and display of a point of sale device, in which the display shows a list order screen, using which an order from a list of pending orders can be selected for processing or rejection.

FIG. 8 illustrates a keypad and display of a point of sale device, in which the display shows a browse order screen, using which the details of a customer's order can be viewed.

### DETAILED DESCRIPTION OF THE PREFERRED EMBODIMENTS

The preferred embodiment of the invention provides a system including a retail point of sale device including a micro-controller, or defining a microprocessor-based system, and having a keypad, display, and printer. The point of sale device of the preferred embodiment further includes a memory, such as a read-only memory, on which there is embedded software to interface the point of sale device to the application server, and to interface with the keypad, display and printer. The point of sale device further includes memory for program data storage, a communication interface to connect to the Internet, a display, a keypad to provide a user interface, and a printer to print transactions. The point of sale device further includes an audio speaker and visual indicators to alert the retailer. These components are packaged in a common housing as an inexpensive point of sale device. The term “point of sale device,” as used herein, is meant to exclude general-purpose programmable personal computers that merely have point of sale software installed. Instead, the term refers to hardware designed specifically for use as a point of sale device.

The system of the preferred embodiment of the invention further includes an application server. The point of sale device interacts with the application server, which is in communication with the Internet shop server. The application server can either run as an independent server or work as a part of the Internet shop server and provides interaction between point of sale device and the Internet shop server. This application server retrieves the status of an order from the point of sale device and posts the status directly to the Internet shop server. This way, a consumer can get a live update of the status of his or her orders.

When the retailer publishes a shop on the Internet, shop specific information and inventory information is posted in a database that can be accessed by the Internet shop server. In one embodiment, the database is defined by a memory included in the shop server. By modifying this database or by interfacing with an application programming interface of the Internet shop server, the shop information can be modified.

The application server that interfaces with the Internet shop server or with the Internet shop database provides access to the point of sale device. This application server on one side interfaces with the Internet shop server and on the other side allows the point of sale device to connect and retrieve the order or modify the shop specific information. The application server has the ability to monitor and look for an order placed on the Internet shop server. The application server receives events from Internet shop server to indicate an order. When the consumer places an order, the Internet shop server indicates to the point of sale interface application server that there is an order pending for process. The application server then checks the order and finds the retailer identification. Using the retailer identification it pushes a message to that retailer's point of sale device. If the device is not connected all the time to the network, then the application server initiates a call to physically connect to the retail point of sale device and then sends the message. The retail point of sale device, when it receives such a message, activates the audiovisual indicator.

In one embodiment, the point of sale device has browse, print, and change buttons. When the retailer pushes the browse button on the point of sale device, orders are shown on the display, and the retailer can select an order for processing. To process the order he can push the print button to print out a purchase order with details about the consumer and his order request. Once he prints an order placed by the consumer, the point of sale device reports to the application server, which in turn reports to the consumer that the order is being processed. This way, the consumer who placed his order can find out the status of his order. The retailer can set preferences on the point of sale device to indicate to the consumer the shop specific information, such as retail shop operating hours, delivery delays and area of delivery. Using this information the application server projects the approximate delivery time when the consumer places the order.

The retailer can change either the shop specific preference or inventory. To do so, he will push the change button to initiate the process. In response to the change button being pressed, the point of sale device connects to the application server and displays the available options. The available options to the retailer, which are displayed on the display, include, for example, change inventory items or change preference. In response to the change inventory option being selected, the point of sale device provides options on the display using which the retailer can delete, add or change the price of items listed using the alphanumeric keypad. In one embodiment, the display is a touch screen display allowing at least some selections to be made by touching the screen instead of using a keypad. The application server periodically monitors the point of sale device availability to report the status of the shop to the consumer.

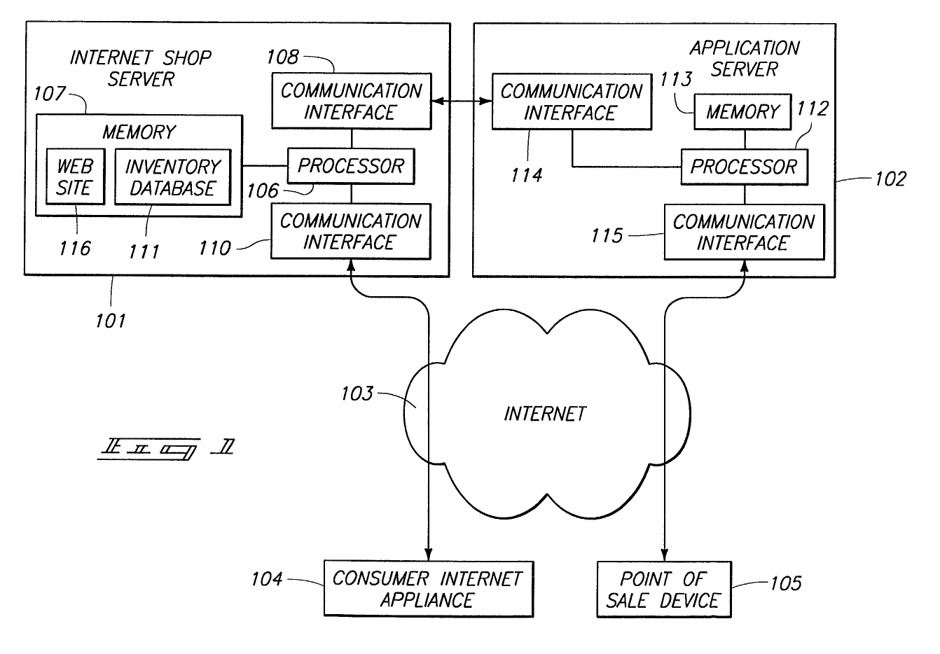

FIG. 1 shows a system embodying various aspects of the invention, as described above, for real time order processing and inventory management. The system includes an Internet shop 101, an application server 102, a consumer Internet appliance 104 and a point of sale device 105.

The consumer Internet appliance 104 is a computer, computer terminal (e.g. iMac™, WebTV™), personal digital assistant, WAP phone, or any other device capable of being used to access a server across a network, such as the Internet, such as by using a web browser.

A server running a multitasking, multi-user operating system, such as Unix or Linux, and running a conventional electronic commerce software application, defines the e-commerce Internet shop or server 101. The server 101 includes conventional sever components such as a processor 106, a memory 107 (e.g. hard drive, disk drive, tape drive, ROM, RAM, optical drive, etc.) coupled to the processor 106, and communication interfaces 108 and 110 coupled to the processor 106, for communicating with the application server 102 and one or more (e.g. simultaneously connected) consumer internal appliances 104.

The memory 107 defines one or more shop web sites 116, for one or more retailers, respectively. One point of sale device 105 is associated with each shop web site 116 and is typically located on the premises of the retailer associated with that shop web site 116.

The memory 107 further defines an inventory database 111 including quantity in stock, and price information, and other typical inventory database information relevant to the products or services being sold (e.g., size, color, manufacturer, options, etc.). The inventory database 111 is in communication with the web site 116.

The server 101 provides interaction between the consumer appliance 104 and multiple shops (e.g., Internet e-commerce web sites) published on it. The e-commerce shop server 101 also has the capability also to interact with the application server 102. The application server 102, by working with the shop server 101 can retrieve orders placed on the shop server 101, or manage the items published on the shop server 101. The application server 102 can serve many of the point of sale devices 105 (e.g., can be used by multiple retailers).

The point of sale device 105 is an embedded device (e.g., includes a memory bearing software) in one embodiment. The point of sale device 105 can connect to the point of sale application server 102 on demand and request an inventory edit operation or receive the orders placed on the Internet shop server 101.

When the point of sale device 105 makes such requests (inventory edit operation or receive orders), the application server 102 contacts the shop server 101 to retrieve and update the information. The application server 102 includes standard server hardware such as a processor 112, a memory 113, communications interfaces 114 and 115, etc. The point of sale application server 102 can also connect to the point of sale device 105 either on demand or stay connected and query or send messages once in a while. The messaging between point of sale device 105 and application server 102 can be exchanged and originated by either the point of sale device 105 or the application server 102.

Transactions between the Internet shop server 101, point of sale application server 102 and point of sale device 105 follow Internet standard methods and can be over Internet 103 or on an Intranet.

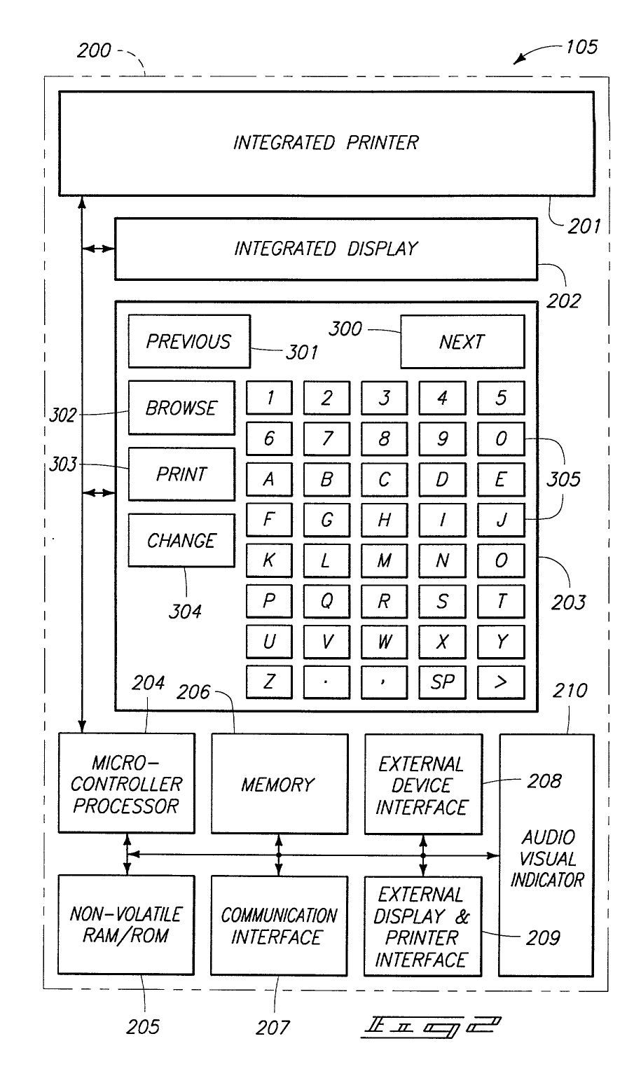

FIG. 2 shows the point of sale device 105 of FIG. 1 in greater detail. The point of sale device is an easy to use, easy to maintain device with minimum complexity. The point of sale device 105 includes a microcontroller/processor 204.

The point of sale device 105 further includes a display 202 coupled to the micro-controller/processor 204. The display 202 can be LED or LCD module or a graphic LCD or other known type of display. The display is driven by the micro-controller or a microprocessor 204.

In the illustrated embodiment, the point of sale device 105 has memory 206, external of the micro-controller/processor 204, for its data storage and operation. The memory 206 is coupled to the micro-controller/processor 204. In an alternative embodiment, the micro-controller/processor 204 includes the memory 206.

The point of sale device 105 further has non-volatile memory or read only memory 205, external of the micro-controller/processor 204, for storing the system software and point of sale device application software. The memory 205 is coupled to the micro-controller/processor 204. In an alternative embodiment, the micro-controller/processor 204 includes the memory 205.

The point of sale device 105 further includes a printer 201 coupled to the micro-controller/processor 204 for printing transaction records.

The point of sale device 105 includes a communications interface or device 207 coupled to the micro-controller/processor 204. The communications interface 207 provides connections to the application server via a network such as Internet and is, for example, a modem (such as a dial-up modem, cable modem for any cabled media such as DSL, POTS, ISDN, etc., satellite modem, wireless modem, etc.); a network card (for connecting to a network via another server), wireless interface such as one compliant with standards such as Bluetooth, WAP, or other proprietary wireless protocols, or a wireless LAN card, etc.; the communications interface can be an Infrared interface; or the communications interface can be one that makes use of proprietary wireless protocols.

The point of sale device 105 further includes an external device interface 208 coupled to the micro-controller/processor 204. The external device interface 208 provides flexibility to extend the device 105 by connecting it to third party payment terminals or point of sale devices.

The point of sale device 105 further includes a keypad or keyboard 203 using which the retailer interacts with the device 105, and an integrated built in printer 201 to print out all orders and additional information sent from application server or as requested by the retailer. In the illustrated embodiment, the keypad 203 is a compact alphanumeric keypad, but is not a full size “QWERTY” keyboard of the type used with personal computers; however, “QWERTY” keyboards, whether full size or compact, are used in alternative embodiments. In the illustrated embodiment, the printer 201 is a low cost printer, such as a thermal, LED, or inkjet printer, but other alternatives are possible.

The point of sale device 105 further includes an audio-visual indicator 210 that alerts the retailer when an order is pending or when the application server needs retailer attention.

The point of sale device 105 further includes an external display/external printer interface 209 to drive external point of sale displays for promotion or advertisements.

In the illustrated embodiment, the point of sale device 105 is compact, having dimensions such as five inches wide by eight to nine inches high and two to three inches thick. Unlike PC-based point of sale devices, the point of sale device 105 has embedded software and a keyboard specifically designed to work with the application server. In the illustrated embodiment, the device 105 is not programmable.

Operation of the point of sale device 105 is made simple by the provision of individual keys like “BROWSE” 302, used to cause the point of sale device 105 retrieve and show the pending orders from the application server. Keys such as previous 301 and next keys 300 are used to cause the point of sale device to show the previous or next available item in the server, and these items can be orders pending or inventory items or just some messages from the server. The print key 303, when pressed by the retailer, causes the point of sale device to print the selected or next available order, and the change key 304, when pressed by the retailer, causes the point of sale device to access the inventory information and allows the retailer to edit the inventory items on the Internet shop server. The retailer, to enter information to the application server, can use the alphanumeric keys 305 built into the keypad 203.

In one alternative embodiment (not shown), the point of sale device 105 further includes a bar code scanner coupled to the micro-controller/processor 204. In this alternative embodiment, or in another alternative embodiment, the point of sale device 105 further includes a credit/debit card reader (not shown) coupled to the micro-controller/processor to process credit card transactions. In such credit card transactions, credit card slips are printed on the printer 201.

The point of sale device 105 further includes a common housing 200 supporting, encasing, surrounding, or otherwise housing the above described components of the point of sale device 105, including the printer 201, display 202, keypad 203, micro-controller/processor 204, memory 206, external device interface 208, audio visual indicator 210, RAM/ROM 205, communication interface 207, and external display & printer interface 209. More particularly, the display 202 and keypad 203 are accessible from outside the housing 200, the audio visual indicator 210 is audible/visible outside the housing 200, while the micro-controller/processor 204, RAM/ROM 205, and memory 206 are inside the housing. The communication interface 207, external device interface 208, and external display and printer interface 209 include respective connectors that are accessible outside the housing.

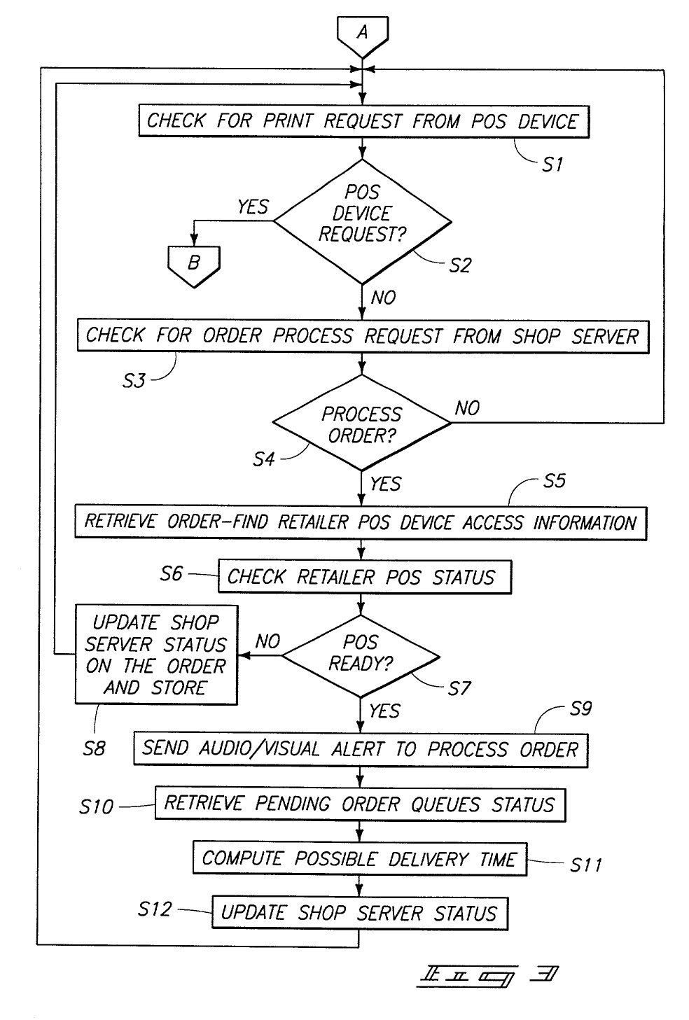

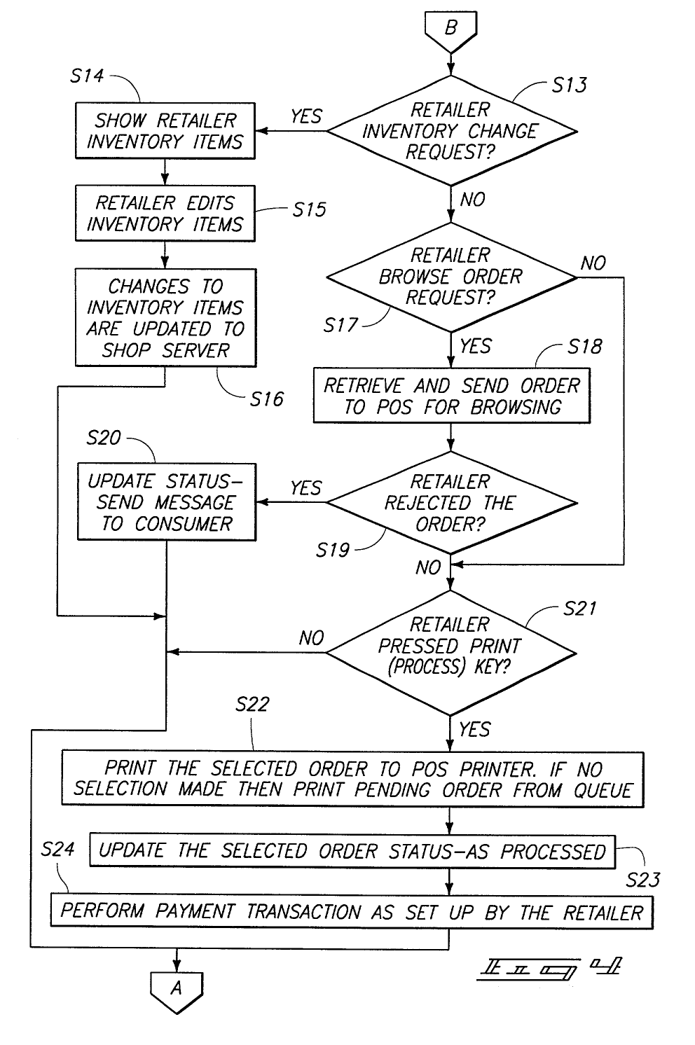

FIGS. 3-4 illustrate the software processes performed by the point of sale device 105 and the application server 102. The application server 102 listens for messages from the point of sale device 105, and similarly the point of sale device listens to the application server 102. Whenever there is an order that has to be processed, the application server 102 contacts the point of sale device 105 to give alerts. The point of sale device 105 can query the application server for all the orders, or for inventory items, or to edit or modify the retailer specific information.

In step S1, the application server 102 checks for a print request from the point of sale device 105.

In step S2, the application server 102 determines if there was a request from the point of sale device 105. If so, the application server 102 proceeds to step S13. If not, the application server 102 proceeds to step S3.

In step S3, the application server 102 checks for an order process request from the shop server 101.

In step S4, the application server 102 determines if there is an order process request from the shop server 101. If so, the application server 102 proceeds to step S5. If not, the application server proceeds to step S1.

In step S5, the application server 102 retrieves the order from the shop server 101 and finds retailer point of sale device 105 access information. If there are many retailers serviced by the shop server 101, the shop server 101 uses the access information to contact the appropriate retailer's point of sale device 105. After performing step S6, the application server 102 proceeds to step S7.

In step S7, the application server 102 determines if the appropriate retailer's point of sale device 105 is ready. If so, the application server 102 proceeds to step S9. If not, the application server 102 proceeds to step S8.

In step S8, the application server 102 updates the shop server status regarding the order and regarding the store. After performing step S8, the application server 102 proceeds to step S1.

In step S9, the application server 102 sends a signal to cause the audio/visual indicator 210 to actuate to indicate to the retailer that an order is ready to be processed. After performing step S9, the application server 102 proceeds to step S10.

In step S10, the application server 102 retrieves pending order queues status information from the point of sale device. After performing step S10, the application proceeds to step S11.

In step S11, the application server 102 calculates anticipated delivery times for accepted orders by adding shipping delay associated with the selected delivery method to typical processing time. If the ordered item is out of stock, the anticipated amount of time to obtain the item is also added. After performing step S11, the application server 102 proceeds to step S12.

In step S12, the application server 102 sends data to the shop server, to update the shop server status, e.g., to indicate which orders have been accepted by the retailer from the pending order queue, anticipated delivery time, and change in available inventory. After performing step S12, the application server proceeds to step S1.

In step S13, the application server 102 determines if the retailer has made an inventory change request using the point of sale device 105 (e.g., by pressing “CHANGE” button 304). If so, the application server 102 proceeds to step S14. If not, the application server 102 proceeds to step S17.

In step S14, application server 102 communicates retailer inventory to the point of sale device 105, and the inventory is displayed on the display 202.

In step S15, the point of sale device 105 inputs edits to the inventory items via the keypad 203.

In step S16, the application server 102 causes changes made to inventory items to be updated to the shop server 101. After performing step S16, the application server 102 proceeds to step S1.

In step S17, the application server 102 determines whether the retailer made a browse order request using the point of sale device 105 (e.g., by pressing “BROWSE” button 302). If so, the application server proceeds to step S18. If not, the application server proceeds to step S21.

In step S18, the application server 102 retrieves orders from the shop server 101 and sends them to the point of sale device 105 for browsing. After performing step S18, the application server 102 proceeds to step S19.

In step S19, the application server 102 determines whether the retailer rejected an order, using the point of sale device 105. If so, the application server 102 proceeds to step S20. If not, the application server 102 proceeds to step S21.

In step S20, the application server 102 updates the status of the order on the shop server 101 and indicates to the consumer that the order was rejected, e.g., by e-mail as well as on a status web page. After performing step S20, the application server 102 proceeds to step S1.

In step S21, the point of sale device 105 determines whether the retailer pressed the “PRINT” key 303. If so, in step S22, the point of sale device 105 prints the selected order. If no selection was made before the “PRINT” key was pressed, then a pending order (e.g., the first or oldest order in the queue) is automatically selected and printed.

In step S23, the application server 102 updates the order status of the selected order to indicate that the order was processed. After performing step S23, the application server 102 proceeds to step S24.

In step S24, the application server initiates a payment transaction as set up by the retailer (e.g., by processing a credit card number previously entered on a web page of the Internet shop server 101 when the consumer placed the order).

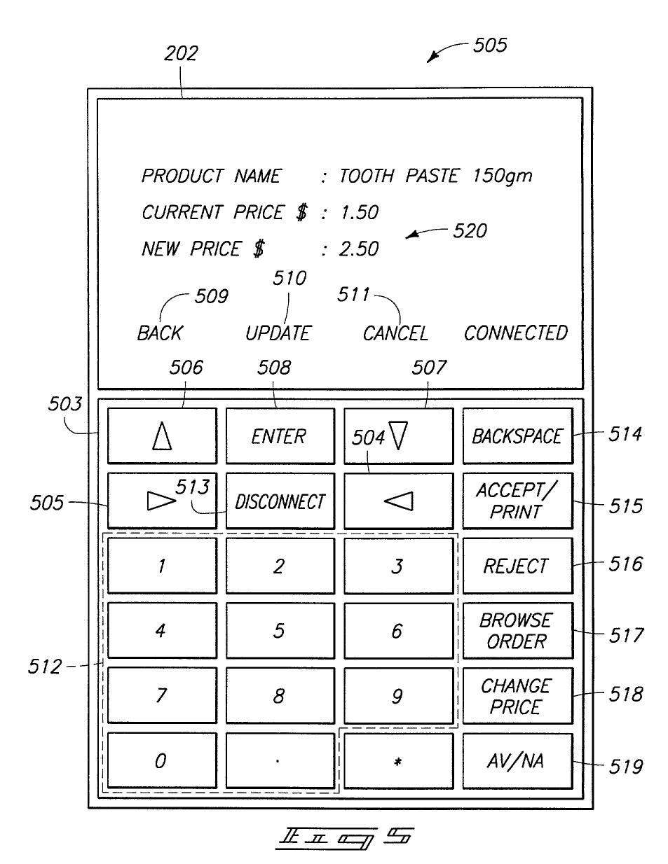

FIG. 5 illustrates a point of sale device 505 that has alternative keypad 503, but is otherwise similar to the point of sale device 105 of FIG. 2. The keypad 503 includes left, right, up, and down, navigation keys 504, 505, 506, and 507 for navigating menus shown on the display 202 or changing changeable fields shown on the display 202, and an Enter key 508. In the embodiment shown in FIG. 5, some keys (e.g., 506, 508, and 507) of the keypad are adjacent the display 202 so that function names (e.g., 509, 510, 511) can be shown on the display 202 adjacent the keypad. Pressing the key adjacent the function name shown on the display will cause that function to be processed.

The keypad 503 also includes a disconnect button 513 which, if pressed, cause the point of sale device 105 to disconnect the communications link with the application server 102. The keypad 503 further includes a backspace key 514; e.g., for making corrections, an accept key 515 for accepting an order and causing it to be printed on the printer 201 as described above, a reject key 516, for rejecting an order, a browse key 517, for browsing through orders as described above, a change price button 518, and a status change button 519, for changing the status of an inventory item (e.g., marking inventory as being available or not available).

As should be apparent, different arrangements of keys and labels for the keys can be employed, while still allowing the functions described above in connection with FIGS. 1-4 to be performed. Alphabetical keys are added to the keypad 503 in one alternative embodiment.

The screen shown in FIG. 5 on the display 202 is a change price screen for changing prices of inventory items. For example, to change a price of a product after reaching the change price screen, the retailer uses numerical keys 512 to enter a new price in a New Price field 520, and presses the Enter key 508 (adjacent the function name “Update” 510) to update the price. The change price screen is reached by pressing a button; e.g., the button 518.

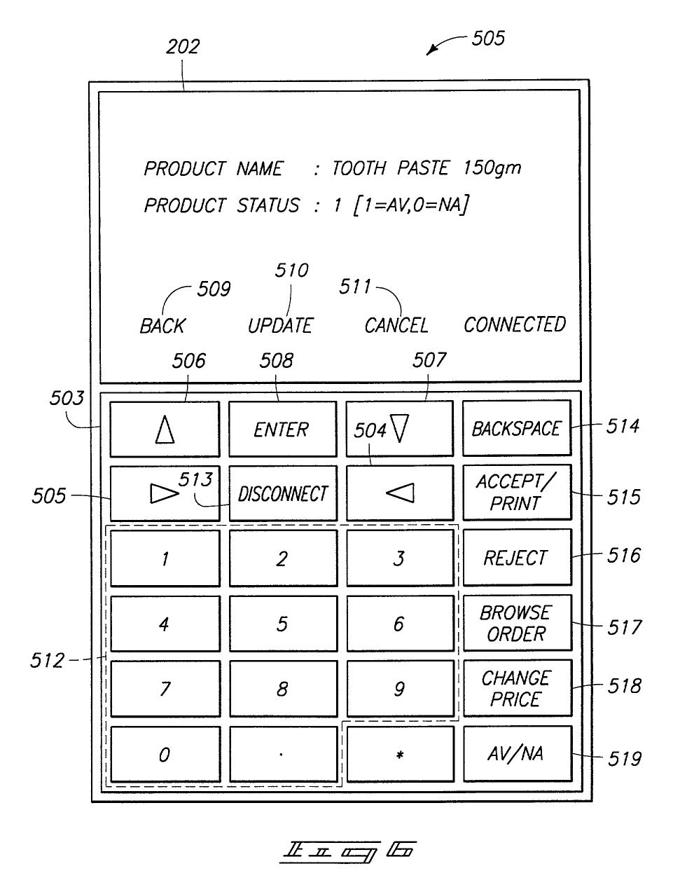

The screen shown in FIG. 6 on the display 202 is a change product status screen, from which the availability status of a product can be changed using the key 519. For example, in the illustrated embodiment, the status of a product can be changed between a status of available and a status of non-available by pressing keys; e.g., the numeric 1 key or the 0 key. The product status selected is shown on the display 202. The product status screen shown in FIG. 6 can be reached by pressing a key; e.g., the key 519.

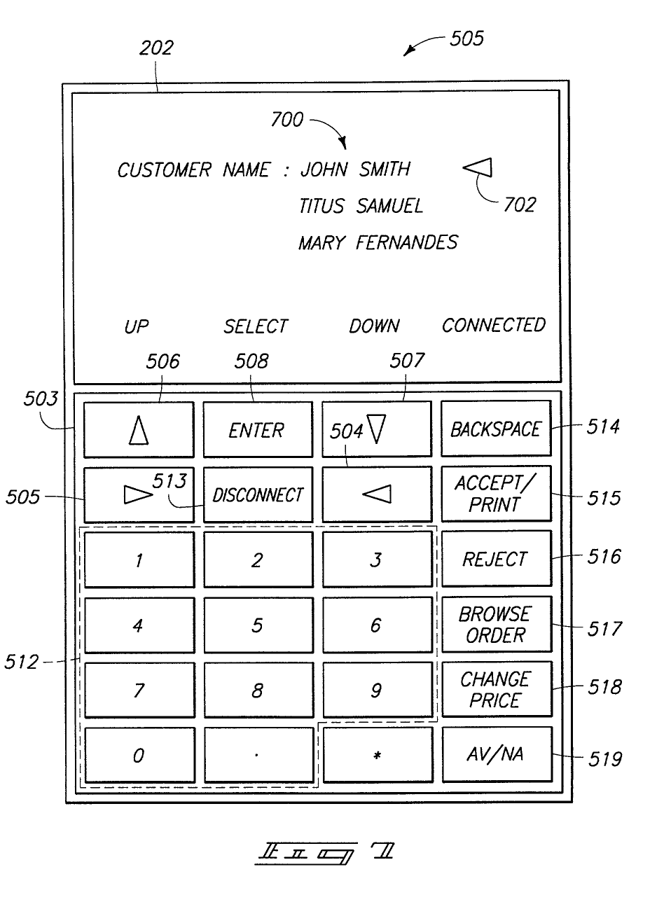

The screen shown in FIG. 7 on the display 202 is a list order screen, using which an order from a list of pending orders can be selected for processing or rejection. A list of orders 700 is shown on the display 202, as well as a pointer or arrow 702. Instead of using an arrow, other methods can be used to toggle through the orders; e.g., highlighting, underlining, bolding, etc. The navigation keys 506 and 507 are used to move the pointer to one of the listed orders, and the enter key 508 is pressed to select the indicated order for processing. In the illustrated embodiment, orders are identified by customer name; however, other alternatives are possible (e.g., orders can be identified by dollar amount, date, account number, etc.). The list order screen shown in FIG. 7 can be reached by pressing a key; e.g., the browse key 517.

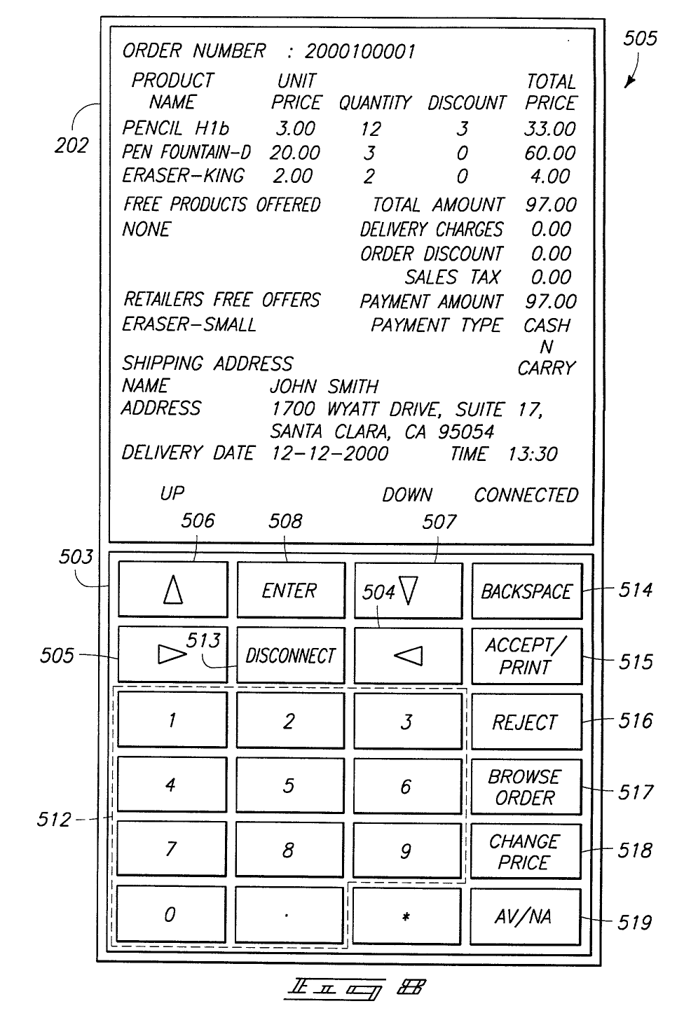

The screen shown in FIG. 8 on the display 202 is a browse order screen, using which the details of a customer's order can be viewed. The order can be rejected by pressing a button; e.g., the reject button 516, or accepted by pressing the accept/print button 515. When the accept/print button is pressed, the order is printed on the printer 201. The printed order will be substantially similar in arrangement to what is shown on the screen in FIG. 8, and will indicate, for example, one or more of: product names, unit prices, quantities, discounts, total prices, taxes (if applicable), purchaser's name, purchaser's address, type of payment (e.g., credit card, check, cash), etc.

The orders placed by customers will be placed using web pages which can be substantially similar to any of the e-commerce shopping and order pages in existence (e.g., Yahoo™ Shopping, Alta Vista™ Shopping, Amazon.com™, Buy.com, etc.). In one embodiment, the web pages employed are such that at least one web page of the site lists multiple different retailers or presents information and/or advertising for multiple different retailers, which retailers possess the point of sale devices 105. In one embodiment, a retailer-specific web page can be reached from this page. The orders can also be placed on the retailer's premises.

Thus, an inexpensive point of sale device has been provided that can be used by retailers with minimal computer ability to manage an e-commerce shop, retrieve orders, and manage and update inventory and shop specific information on an e-commerce server. The point of sale device has a printer, display, and keypad in a common housing and is therefore very compact.

The protection sought is not to be limited to the disclosed embodiments, which are given by way of example only, but instead is to be limited only by the scope of the appended claims as properly interpreted in accordance with the doctrine of equivalents.

1. A system comprising:
a point of sale device including:
a housing;
a processor supported by the housing;
a printer coupled to the processor and supported by the housing;
a display coupled to the processor and supported by the housing;
a keypad coupled to the processor and supported by the housing; and
a communications interface coupled to the processor and supported by the housing, the communications interface being configured to communicate with a server via the Internet.

2. A system in accordance with claim 1 and further comprising an application server configured to selectively communicate with the point of sale device to provide communications between the point of sale device and an e-commerce server.

3. A system in accordance with claim 2 and further comprising an e-commerce server in communication with the application server, the e-commerce server comprising a memory having stored thereon files defining a retailer web site, the e-commerce server including a communications interface for coupling the e-commerce server to the Internet, the e-commerce server being configured to run a multi-user multi-tasking operating system, wherein a consumer can access the retailer web site via a client machine having a web browser and place orders, and the e-commerce server being configured to communicate such orders to the application server.

4. A system in accordance with claim 3 wherein the e-commerce server further includes a database including inventory information comprising prices and in-stock quantities of products, and wherein the point of sale device communicates with the database via the application server such that a retailer can adjust the inventory information using the point of sale device.

5. A system in accordance with claim 2 wherein the point of sale device is configured to selectively initiate a connection to the application server.

6. A system in accordance with claim 2 wherein the application server is configured to selectively initiate a connection to the point of sale device.

7. A system in accordance with claim 4 wherein the keypad of the point of sale device includes a single button interface which, when pressed, allows a retailer to browse through placed orders, wherein each time the button is pressed, the display of the point of sale device changes the displayed order to show another placed order.

8. A system in accordance with claim 4 wherein the point of sale device is configured to show placed orders on the display, and wherein the keypad of the point of sale device includes a single button interface which, when pressed, allows a retailer to print the placed order that is shown on the display of the point of sale device.

9. A system in accordance with claim 4 wherein the keypad of the point of sale device includes a single button interface which, when pressed, allows a retailer to change inventory quantities and prices in the database, the point of sale device being configured to show the inventory quantities and prices on the display of the point of sale device in response to the button being pressed.

10. A system in accordance with claim 3 wherein the point of sale device printer is configured to print orders, wherein the point of sale device further includes an external printer interface using which an external printer can selectively be coupled to the point of sale device to print orders.

11. A system in accordance with claim 4 wherein the point of sale device further includes an external display interface, using which orders and inventory information can be displayed on an external display.

12. A system in accordance with claim 1 wherein the processor is an embedded processor.

13. A system in accordance with claim 3 wherein the processor of the point of sale device includes a memory bearing software code configured to drive menus for inventory management based on communications between the point of sale device and the application server.

14. A system in accordance with claim 3 wherein the point of sale device includes a selectively actuable audio-visual indicator, wherein the application server transmits a signal to the point of sale device indicating that an order has been received by the e-commerce server, and wherein the audio-visual indicator actuates in response to the signal.

15. A system in accordance with claim 3 wherein the point of sale device is configured to selectively connect to an external payment clearance device to process payments for orders.

16. A system in accordance with claim 3 wherein the e-commerce server memory has stored thereon files defining multiple retailer web sites, wherein the application server is configured to selectively connect to one or more of multiple of said point of sale devices and to route orders to different point of sale devices based on the retailer web sites on which the orders were placed.

17. A system comprising:
a point of sale device including a housing; a processor supported by the housing; a printer coupled to the processor and supported by the housing; a display coupled to the processor and supported by the housing; a keypad coupled to the processor and supported by the housing; and a communications interface coupled to the processor and supported by the housing;
an e-commerce server selectively coupled to the point of sale device via the communications interface of the point of sale device, the e-commerce server including a memory having stored thereon files defining a retailer web site, the e-commerce server including a modem for coupling the e-commerce server to the Internet, the e-commerce server being configured to run a multi-user multi-tasking operating system, wherein a consumer can access the retailer web site via a client machine and place orders for merchandise; and
an application server configured to receive orders from the e-commerce server and selectively communicate with the point of sale device to transmit orders to the point of sale device for printing by the printer of the point of sale device.

18. A system in accordance with claim 17 wherein the e-commerce server further includes a database including inventory information comprising prices and in-stock quantities of products, and wherein the point of sale device communicates with the database via the application server such that a retailer can adjust the inventory information using only the point of sale device.

19. A method comprising:
providing a point of sale device including a processor; a printer coupled to the processor; a display coupled to the processor; a keypad coupled to the processor; and a communications interface coupled to the processor;
defining a retailer web site using an e-commerce server such that a consumer can access the retailer web site by connecting to the e-commerce server via a client machine and place orders for merchandise; and
receiving orders using an application server, from the e-commerce server and communicating with the point of sale device to transmit orders to the point of sale device.

20. A method in accordance with claim 19 and further comprising defining a database on the e-commerce server, the database storing inventory information, and adjusting the inventory information using the point of sale device.
